(19) United States
(12) Patent Application Publication
(10) Pub. No.: US 2004/0031927 A1
(43) Pub. Date: Feb. 19, 2004

(54) Indicating apparatus for skin protection against sunshine

(75) Inventors: Feng-Nien Tsai, Kaohsiung (TW); Wei-Cheng Chen, Tao-Yuan (TW)

Correspondence Address: BACON & THOMAS, PLLC, 625 SLATERS LANE, FOURTH FLOOR, ALEXANDRIA, VA, 22314

(73) Assignees: A & D Sports Timer Co., Ltd., Tao-Yuan (TW); Chen Chang Co., Ltd., Kaohsiung (TW)

(21) Appl. No.: 10/263,733

(22) Filed: Oct. 4, 2002

(30) Foreign Application Priority Data
Aug. 16, 2002 (TW) 91212729

(51) Int. Cl. G01J 5/10

(52) U.S. Cl. 250/372

(57) ABSTRACT

An indicating apparatus for skin protection against sunshine a power unit, a control IC connected to the power unit, a display panel electrically connected to the control IC, the display panel having display areas for displaying UV intensity, dermatoglyphics characteristics, and sun protection factor data, a UV sensor electrically connected to the control IC and adapted to detect UV intensity of sunlight, a signal converter adapted to convert analog UV intensity signal from the UV sensor into electronic signal for the control IC, and an input device electrically connected to the control IC for data entry of the user's dermatoglyphics characteristics for enabling the control IC to compute inputted data and to output sun protection factor reference data to the display panel for reference by the user.

### BACKGROUND OF THE INVENTION

1. Field of the Invention

The present invention relates to a personal electronic instrument for use when being outdoors and, more specifically, to an indicating apparatus for skin protection against sunshine, which suggests the user to take proper sun protection measures subject to UV intensity of sunlight and personal dermatoglyphics characteristics.

2. Description of the Related Art

In order to have good health and beauty, the attack of UV light is more and more cared by people. However, excessive radiation of UV light may injure the skin cells or cause microvascular diseases. Therefore, it is necessary to apply a sun blocking cream or suntan lotion to the skin when taking a sunbath or going outdoors under the radiation of the sun. Before taking a sunbath or going outdoors, people may use a UV sensor to detect UV intensity of sunlight, or select a sun blocking cream or suntan lotion subject to current sun protection factor reported by the weather reporter. However, it is not absolutely correct to determine the type of sun blocking cream or suntan lotion subject to current UV intensity of sunlight because different dermatoglyphics characteristics achieve different UV protection effect. Further, all commercially available sun protection devices such as sun blocking creams, suntan lotions, sunshades, or UV sensors cannot provide the user with sufficient sun protection.

### SUMMARY OF THE INVENTION

The present invention has been accomplished under the circumstances in view. It is the main object of the present invention to provide an indicating apparatus for skin protection against sunshine, which suggests the user to adopt suitable sun protection measures when being exposed under sunshine. It is another object of the present invention to provide an indicating apparatus for skin protection against sunshine, which provides the user with additional information including cardiac rhythm, ambient temperature, and etc. To achieve these and other objects of the present invention, the indicating apparatus for skin protection against sunshine comprises an indicating apparatus for skin protection against sunshine comprising: a power unit for providing DC power; a control IC being electrically connected to said power unit, said control IC being adapted to receive and compute externally inputted data and to output computed data for display; display means being electrically connected to said control IC for displaying outputted data from said control IC, said display means comprising a plurality of display areas for displaying UV intensity, dermatoglyphics characteristics, and sunshine protection factor data; a UV sensor being electrically connected to said control IC and for detecting UV intensity of sunshine; a signal converter being electrically connected in series between said control IC and said UV sensor and being adapted to convert analog UV intensity signal from said UV sensor into electronic signal for said control IC; and an input device being electrically connected to said control IC for data entry of the user's dermatoglyphics characteristics for enabling said control IC to compute inputted data and to output sunshine protection factor reference data to said display means for reference by the user.

### BRIEF DESCRIPTION OF THE DRAWINGS

FIG. 1 is a system block diagram of a sunbathing sun protection reference apparatus according to the present invention.

FIG. 2 is a circuit diagram of the sunbathing sun protection reference apparatus according to the present invention.

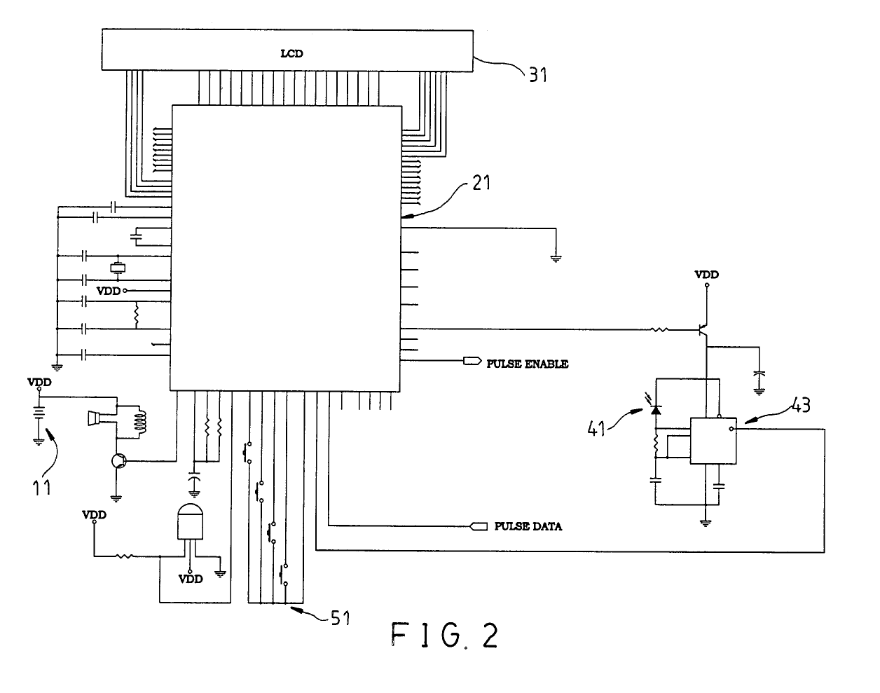

FIG. 3 shows an example of the display of the display sections of the display panel according to the present invention.

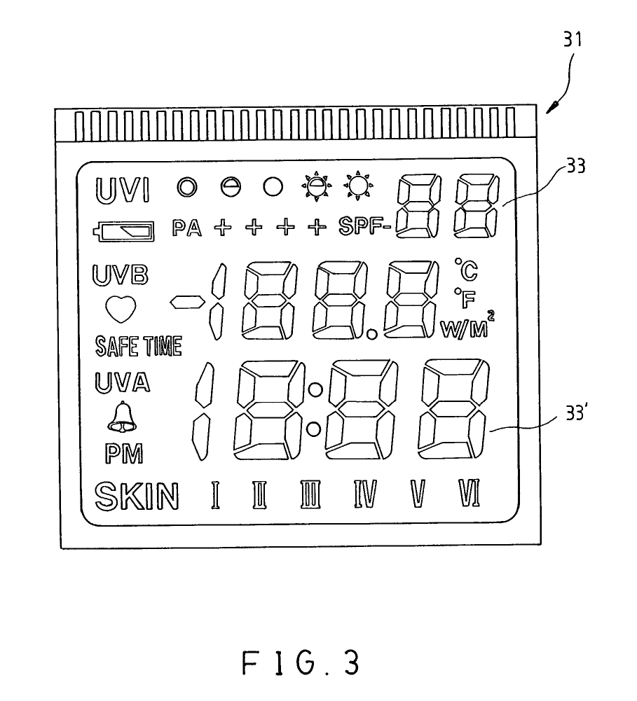

### DETAILED DESCRIPTION OF THE PREFERRED EMBODIMENT

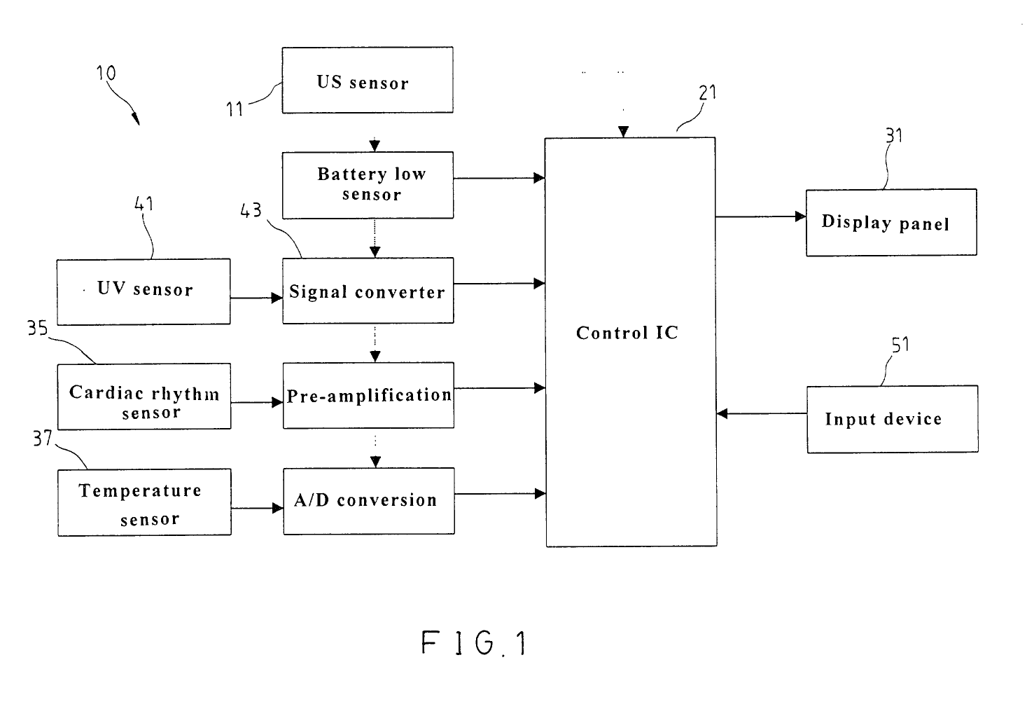

Referring to FIGS. 1˜3, an indicating apparatus for skin protection against sunshine 10 in accordance with the present invention is shown comprised of a power unit 11, a control IC 21, a display panel 31, an UV sensor 41, and an input device 51.

The power unit 11 is comprised of at least one battery adapted to provide the apparatus 10 with the necessary working DC power.

The control IC 21 is a programmable IC chip, for example, an ASIC (Application Specific Integrated Circuit) connected to the power unit 11 for receiving and computing external input signal and outputting computed value. According to the present preferred embodiment, the control IC 21 receives dermatoglyphics characteristics data inputted by the user, and computes the data subject to UV intensity of sunlight obtained from the UV sensor 41, and then lists sun block lotion SPF (Sun Protection Factor) suitable for the user.

The display panel 31 is electrically connected to the control IC 21, having multiple display areas 33 for the display of UV intensity, dermatoglyphics characteristics, and SPF data respectively. The display panel 31 further has display areas 33′ for displaying safety exposure time to sunlight, heart beat ratio, ambient temperature, and current time respectively. The heart beat ratio is detected by a cardiac rhythm sensor 35, which is electrically connected to the control IC 21 to input the heart beat data of the user into the control IC 21 for display on the display panel 31. The ambient temperature is obtained from a temperature sensor 37, which is electrically connected to the control IC 21. The control IC 21 directly displays its system time on the display panel 31.

The UV sensor 41 is connected to the control IC 21 through a signal converter 43, which converts UV intensity data into electronic signal and inputs the signal into the control IC 21.

The input device 51 is comprised of a set of buttons respectively electrically connected to the control IC 21 for data entry.

When in use, the user inputs personal dermatoglyphics characteristics data (generally, human skin includes six dermatoglyphics characteristics) into the apparatus 10 via the input device 51. At the same time, the UV sensor 41 detects UV intensity of sunlight. Inputted dermatoglyphics characteristics data and detected UV intensity data are computed by the control IC 21, and the computed result is displayed on the display panel 31. Therefore, the user can determine to choice the most suitable sun block lotion subject to the reference data displayed on the display panel 31.

Further, the indicating apparatus for skin protection against sunshine 10 can also compute the safety exposure time to sunlight subject to the user's dermatoglyphics characteristics and current environmental UV intensity, and display the safety exposure time to sunlight on the display panel 31. The current time, the user's heart beat ratio, and the ambient temperature can also be displayed on the display panel 31 for reference.

The major function of the indicating apparatus for skin protection against sunshine 10 is the provision of the reference of sun protection factor. However, it is to be understood that various modifications and changes could be made thereunto without departing from the spirit and scope of the invention disclosed.

As indicated above, the invention provides the advantages as follows:

1. Users can know the safety exposure time to sunlight and, can determine to use sun block lotion having a suitable sun protection factor fitting the user's dermatoglyphics characteristics.

2. The apparatus also provides additional information such as cardiac rhythm, ambient temperature, current time, etc.

What the invention claimed is:

1. An indicating apparatus for skin protection against sunshine comprising:
a power unit for providing DC power;
a control IC being electrically connected to said power unit, said control IC being adapted to receive and compute externally inputted data and to output computed data for display;
display means being electrically connected to said control IC for displaying outputted data from said control IC, said display means comprising a plurality of display areas for displaying UV intensity, dermatoglyphics characteristics, and sunshine protection factor data;
a UV sensor being electrically connected to said control IC and for detecting UV intensity of sunshine;
a signal converter being electrically connected in series between said control IC and said UV sensor and being adapted to convert analog UV intensity signal from said UV sensor into electronic signal for said control IC; and
an input device being electrically connected to said control IC for data entry of the user's dermatoglyphics characteristics for enabling said control IC to compute inputted data and to output sunshine protection factor reference data to said display means for reference by the user.

2. The indicating apparatus for skin protection against sunshine as claimed in claim 1, wherein said display means further comprises a display area adapted to display safety exposure time to sunshine for the user.

3. The indicating apparatus for skin protection against sunshine as claimed in claim 1, wherein said power supply unit is comprised of at least one battery.

4. The indicating apparatus for skin protection against sunshine as claimed in claim 1, wherein said control IC is a programmable IC.

5. The indicating apparatus for skin protection against sunshine as claimed in claim 1, wherein said display means further comprises a display area adapted to display current time generated by said control IC.

6. The indicating apparatus for skin protection against sunshine as claimed in claim 1, further comprising a cardiac rhythm sensor electrically connected to said control IC and adapted to detect the cardiac rhythm of the user and to display the detected result on said display means.

7. The indicating apparatus for skin protection against sunshine as claimed in claim 1, further comprising a temperature sensor electrically connected to said control IC and adapted to detect ambient temperature and to display detected ambient temperature on said display means.

8. The indicating apparatus for skin protection against sunshine as claimed in claim 1, wherein said input device is comprised of a set of buttons.
